(19) United States
(12) Patent Application Publication
(10) Pub. No.: US 2009/0024942 A1
(43) Pub. Date: Jan. 22, 2009

(54) Document Printing for a Web-Based Data Analysis and Document Review System

(75) Inventors: Brian S. Pendergast, East Greenwich, RI (US); Nicholas C. Croce, Old Brookville, NY (US); Richard Rupp, Plandome Manor, NY (US); Marc Stein, Rego Park, NY (US)

Correspondence Address: FISH & RICHARDSON P.C., P.O. BOX 1022, MINNEAPOLIS, MN, 55440-1022, US

(73) Assignee: Inference Data LLC

(21) Appl. No.: 12/109,052

(22) Filed: Apr. 24, 2008

Related U.S. Application Data
(60) Provisional application No. 60/959,757, filed on Jul. 17, 2007.

(51) Int. Cl. G06F 3/048

(52) U.S. Cl. 715/764

(57) ABSTRACT

A web-based data analysis and document review system is operable to provide a graphical user interface that allows a user to select print options for a group of documents stored by the system. The print options include different print formats each of which offers the user a respective set of features which can be selected for printing the particular group of documents as part of a batch print job.

### CLAIM OF PRIORITY

This application claims priority under 35 USC §119(e) to U.S. Provisional Patent Application Ser. No. 60/959,757, filed on Jul. 12, 2007, the entire contents of which are hereby incorporated by reference.

### TECHNICAL FIELD

This disclosure relates to document printing for a web-based data analysis and document review system.

### BACKGROUND

With the ever-increasing amount of electronic data held by individuals and corporations, the access and analysis of that data has increased the time and budget associated, for example, with litigation and compliance (e.g., Sarbanes-Oxley). These burdens are compounded by the recently amended U.S. Federal Rules of Civil Procedure that mandate production of Electronically Stored Information (“ESI”) and early “meet and confers” to discuss ESI. The legal and business community is therefore faced with additional pressure to manage risk and strategically manage their ESI.

To manage ESI, many have turned to electronic data mining, document review, and document management applications. These applications usually involve (1) a server that houses the ESI for review and access and (2) user terminals that are adapted to review, edit and search the ESI. The server and user terminals interface with each other via a network such as the Internet, an intranet, a LAN and/or WAN. The server usually is coupled to a large data store because the amount of electronic data reviewed/produced in a litigation or generated by a corporation in its ordinary course can easily reach the terabyte (“TB”) range. Often, it is desirable or necessary to print some or all of the documents, for example, in preparation for a document production or deposition, or for some other purpose

### SUMMARY

Various aspects of the invention are recited in the claims.

For example, in one aspect, a web-based data analysis and document review system is operable to provide a graphical user interface that allows a user to select print options for a group of documents stored by the system. The print options include different print formats each of which offers the user a respective set of features which can be selected for printing the particular group of documents as part of a batch print job.

In some implementations, at least one of the print formats gives the user the ability to choose whether the printed documents are to include a watermark, a header, a footer, or Bates-type sequential numbering. The system is operable to print the documents in accordance with the user-selected features.

In some implementations, at least one of the print formats gives the user the ability to choose whether redacted versions of documents are to be included for printing. In such cases, the user can select a redaction set from among a list of available redaction sets. At least one of the print formats can give the user the ability to select how redacted materials are to appear in printed versions of the documents or the ability to choose whether related documents are to be printed.

The disclosed system can provide greater flexibility when printing documents in a batch print job.

Other aspects, features and advantages will be readily apparent from the following detailed description, the accompanying drawings, and the claims.

### BRIEF DESCRIPTION OF THE DRAWINGS

FIG. 1 is an example of a screenshot for a web-based data analysis and document review system.

FIG. 2 is an example of a screenshot illustrating results of a search query.

FIG. 2A is an enlarged version of part of FIG. 2.

FIGS. 3A, 3B and 3C illustrate pop-up windows associated with a standard print format.

FIGS. 4A through 4D illustrate pop-up windows associated with a request for an enhanced print format.

FIG. 5 illustrates an example of a confirmation window.

FIG. 6 illustrates an example of screen to allow a user to access a print job.

FIG. 7 illustrates an example of a system architecture.

FIGS. 8A through 8C illustrate sample pages of a pdf print production.

### DETAILED DESCRIPTION

The web-based data analysis and document review system described in greater detail below provides scalability and advanced concept analytics to allow users to identify key document sets and concepts quickly. Datasets can be analyzed, for example, to determine the potential merits of a case and can help identify the impact of specific keywords and concepts, enabling better preparation for meet and confer, or other, negotiations.

For investigations, the web-based platform provides a powerful analytics solution that enables rapid identification of key documents in very large data stores. A combination of Boolean keyword searching and Bayesian concept analytics allows users to drill down through the dataset, revealing key documents and communications in a few keystrokes.

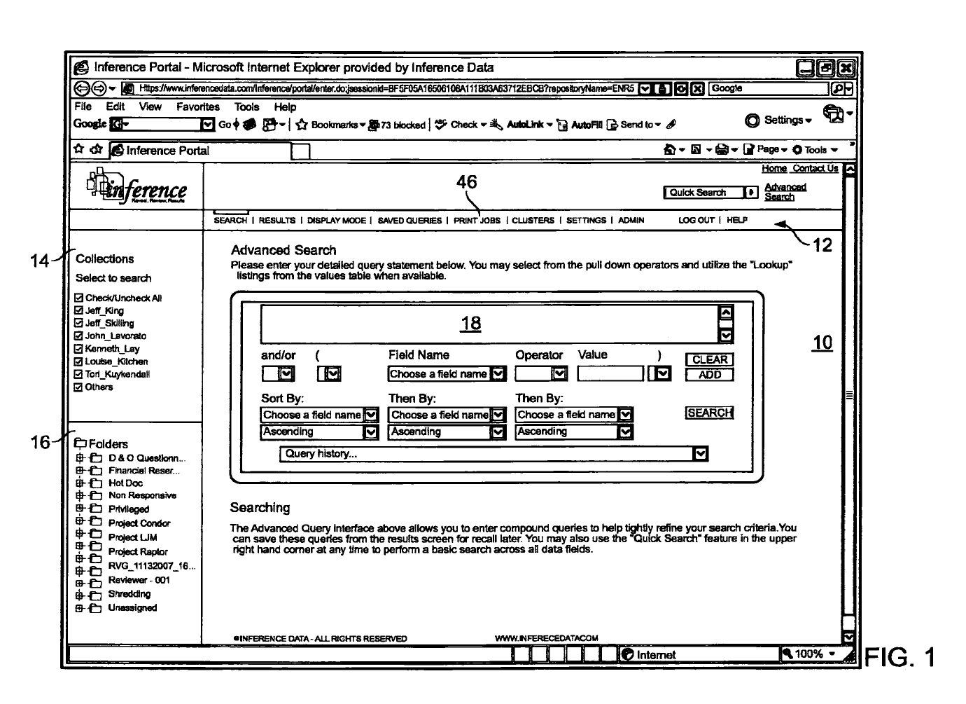

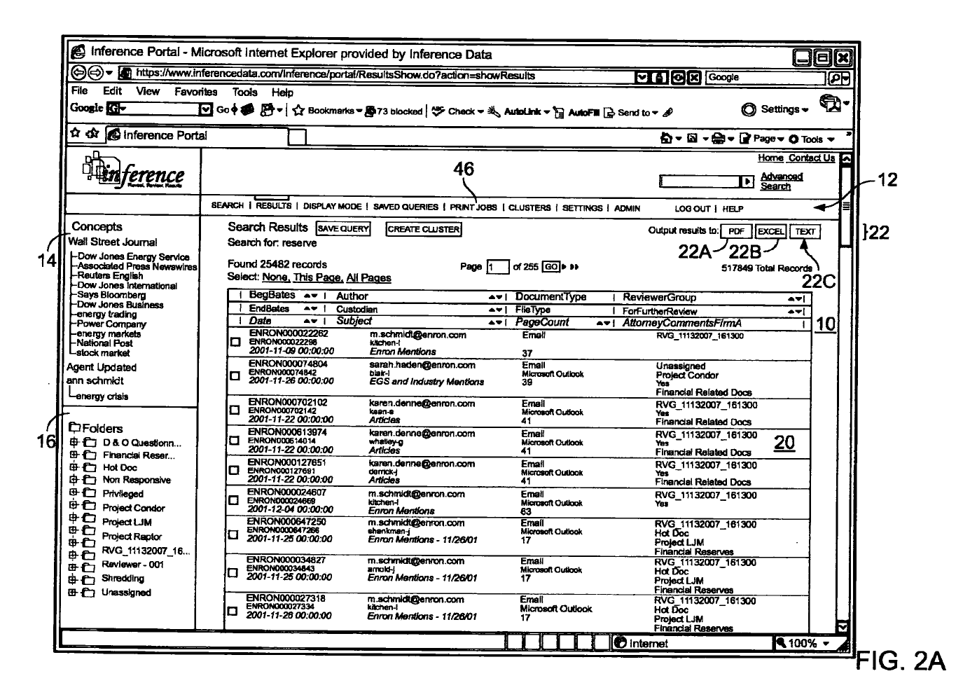

FIG. 1 illustrates an example of the main screen 10 of the web-based platform. The screen 10 provides a graphical user interface and includes a configurable function bar 12 for quick navigation. Among the tabs that can be selected from the function bar 12 are a “Search” tab, a “Results” tab, a “Display Mode” tab, a Saved Queries” tab, a “Print Jobs” tab, a “Clusters” tab, a “Settings” tab and an “Administration” tab.

The screen 10 also lists collections of custodian or data sets 14 and dynamic folders 16 to organize data for the review process. Any of the collections 14 or folders 16 can be selected by a user.

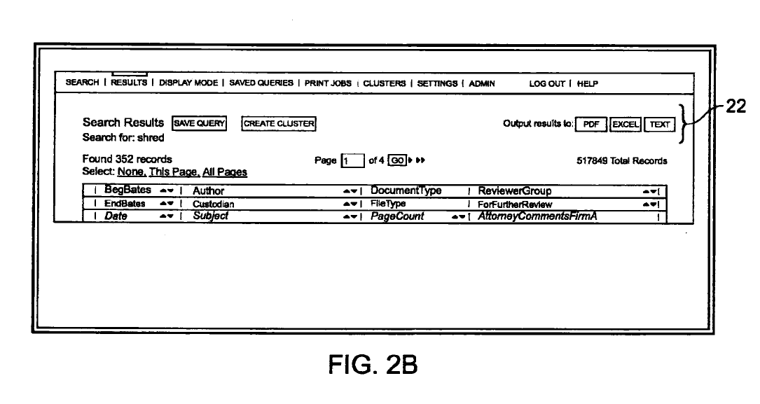

The screen 10 further provides an advanced search pane 18 to drive sophisticated Boolean searching of the selected documents. Upon entry of a search query, the system searches across the selected data set and returns documents related to the user's search. The system highlights dynamic concepts found within the search and allows the user to drill deeper into the concept data set. FIG. 2 illustrates an example of a search results screen 20.

The system enables more efficient and faster review by prioritizing mid and large size document collections into potentially responsive and non-responsive folders. By clustering and then grouping documents into similar concepts across the whole database, folders can be created and assigned to the appropriate level reviewer to aide in workflow management.

After performing a search query and obtaining the results, a user can print a subset of documents for a production or a deposition, or for some other purpose. For example, the platform allows a user to select a single document for production or to generate a large batch print job. As explained below, the results can be enhanced with advanced printing features.

FIG. 2A is an enlarged example of a portion of the results screen 20. The print function is accessed from the upper right-hand corner 22 of the screen with the heading “Output results to:” and the options “PDF,” “EXCEL” and “TEXT.” The illustrated example provides the following two PDF print formats: standard and enhanced. The latter format makes available to the user additional print features such as watermarks and headers/footers.

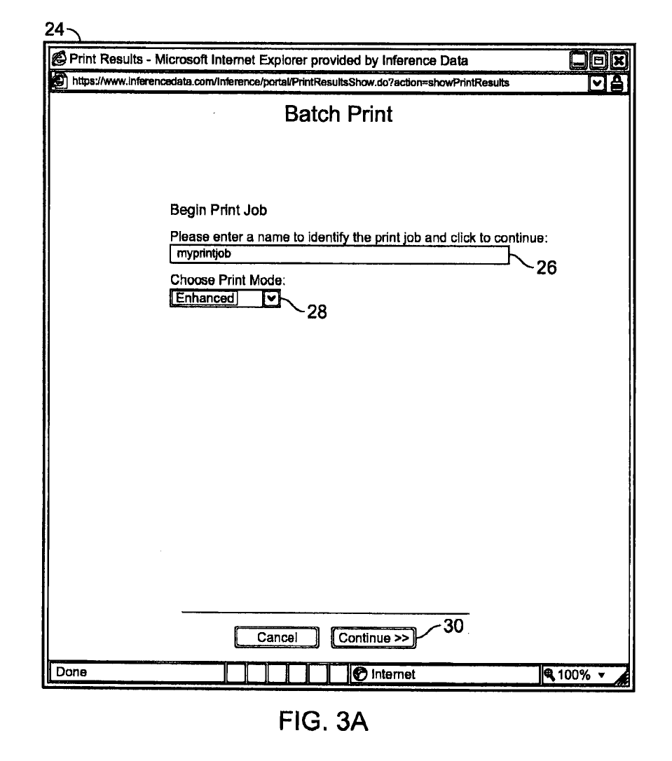

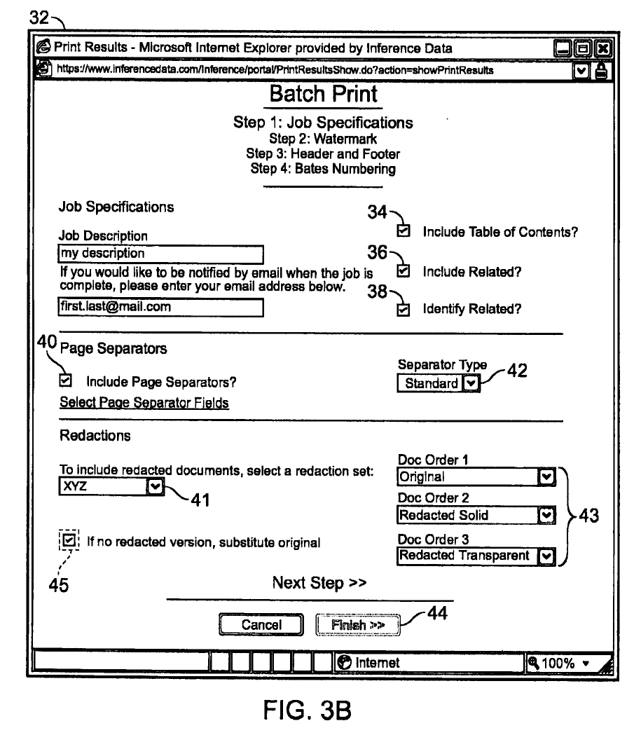

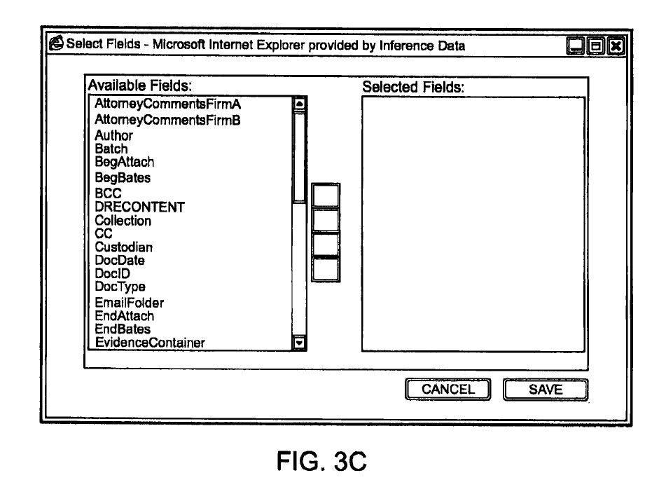

To print documents in the standard format, the user selects the “PDF” button 22A from the results screen (e.g., FIG. 2). In response, the system displays a Batch Print window 24 (see FIG. 3A). In the field 26, the user enters a name for the print job and selects “Standard” from the drop-down menu 28. The user then clicks the “Continue” button 30. In the next window 32 (see FIG. 3B), the user optionally can enter a job description and e-mail address in the designated fields. If the user wishes to include a table of contents for the print job, then box 34 should be checked. Likewise, if the user wishes to include all related documents (e.g., parent, sibling, child) in the output results, then box 36 should be checked. A separate box 38 can be checked if the user wishes to the related documents to be identified in the table of contents. An example of related documents include an e-mail message with an attached file (e.g., a Word document). Another example of related documents is an original e-mail message and a subsequent e-mail message forwarding the original e-mail message.

Some implementations limit the number of documents that can be printed for a single PDF print job. In such cases, the total count of documents to be printed includes the entire family of listed documents, as well as any related documents if box 36 (FIG. 3B) is checked.

If the user wishes to include separator pages in the output between PDF images of different documents, then box 40 should be checked. If box 40 is checked, then an accompanying drop-down menu 42 allows the user to select the type of information that will appear on the separator pages. Options include blank separator pages or separator pages that include specified field names. If the user selects the latter option, then the system displays a separate window that prompts the user to select fields from a list of available items (see FIG. 3C). The user can use arrow buttons to move one or more of the displayed items to a list of selected items. The selected items identify the fields of information that are to be included on the printed separator pages.

The window 32 (FIG. 3B) also allows the user to choose whether redacted documents are to be included and, if so, to select a redaction set from a drop-down menu 41 which lists the available redaction sets for the repository. Other drop-down menus 43 then allow the user to indicate the format in which the redacted documents are to be printed (e.g., whether the redacted text is visible through a transparent window or is not visible). Another option allows the user to check a box 45 to indicate that the original version of the document should be substituted if there is no redacted version of a particular document.

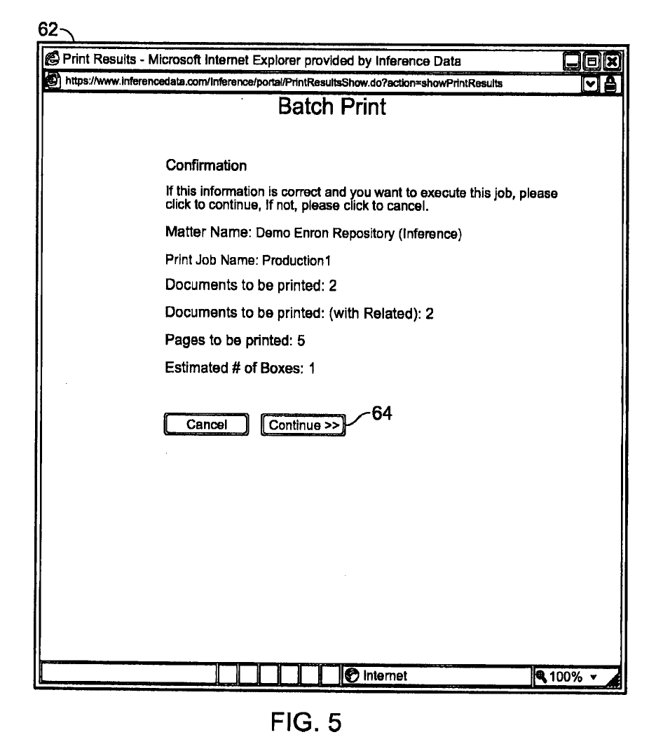

Upon clicking the “Finish” button 44, the system displays a Confirmation window 62 to allow the user to review and confirm the selected print features (see FIG. 5). The user can either cancel the print job by clicking a “Cancel” button or confirm the selections by clicking a “Continue” button 64. If the user clicks the “Continue” button, the print job automatically is saved to a print job list for execution.

To print documents in the enhanced format, the user selects the “PDF” button 22A from the output choices on the results screen (e.g., FIG. 2). In response, the system displays the Batch Print window 24 (see FIG. 3A). In field 26, the user enters a name for the print job and selects “Enhanced” from the drop-down menu 28. The user then clicks the “Continue” button 30.

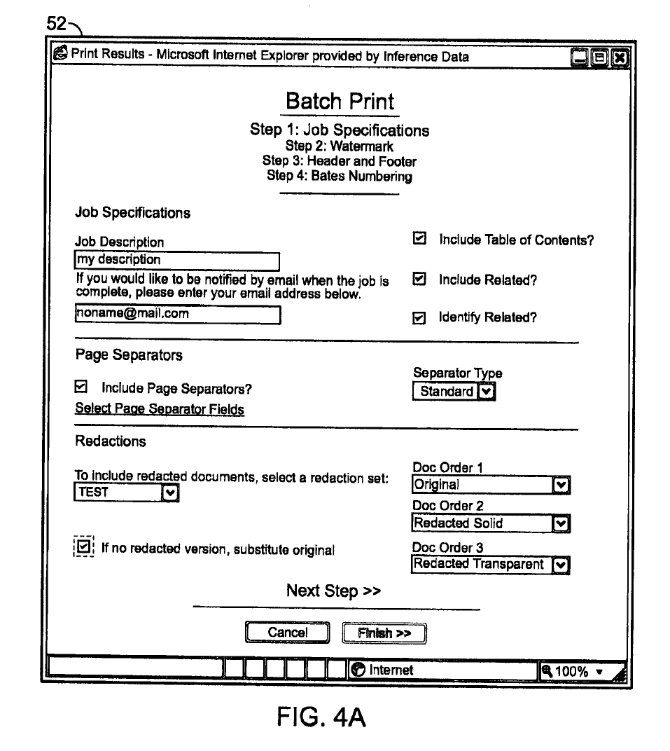

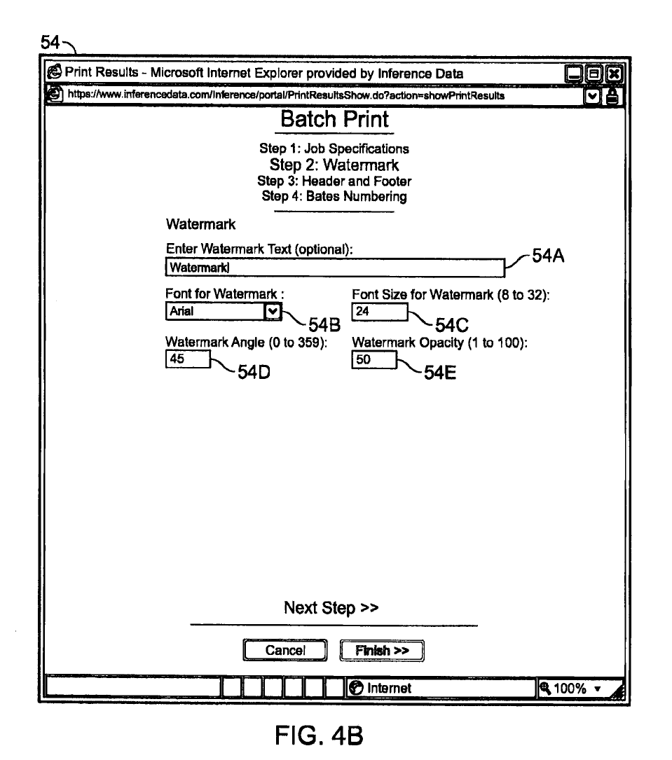

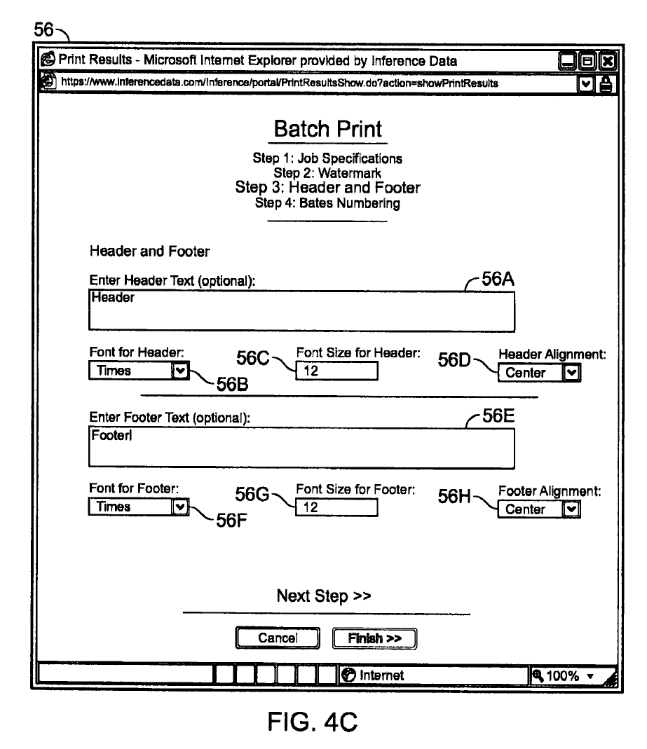

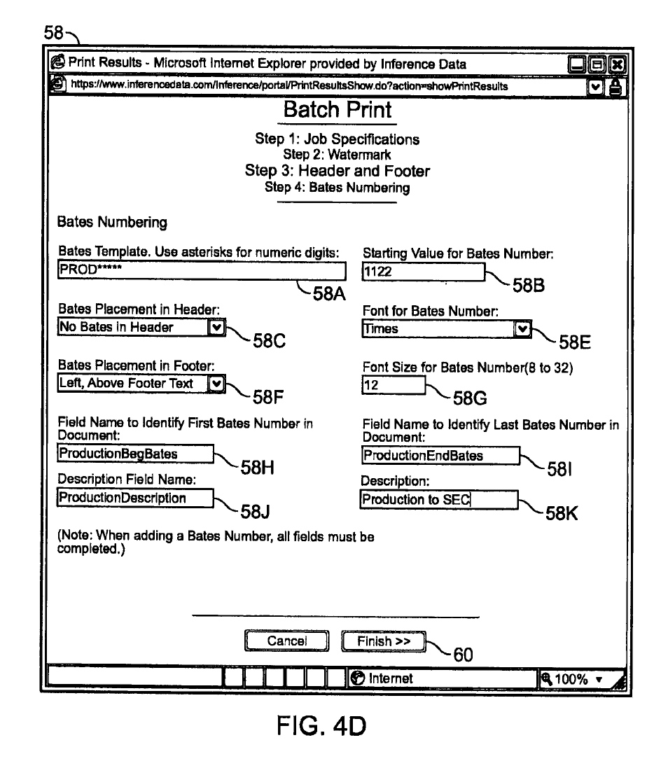

In the next window 52 (see FIG. 4A), which is shared with the standard print format, the user optionally can enter a job description and e-mail address in the designated fields. As explained above in connection with selection of the standard print format, the user can choose to include any or all of the following in the printed output results: a table of contents; related documents (e.g., parent, sibling, child); and redacted documents. The features of window 52 are the same as those described above for window 32 (FIG. 3B).

If the user has selected the enhanced format, then, after completion of the Batch Print window 52 (FIG. 4A), the system displays a window 54 (FIG. 4B) that allows the user to include watermark information on the printed output. Watermark information includes, for example, the text of the watermark, the font and font size, as well as the angle of the watermark (e.g., 0 to 359 degrees) and opacity of the watermark (e.g., 0=invisible; 100=text of the document is occluded). The watermark information can be entered into displayed fields 54A, 54B, 54C, 54D and 54E. Some of the displayed fields provide drop-down menus from which the user can make a selection.

The next window 56 (FIG. 4C) allows the user to enter header and footer information to be printed on the printed documents. In particular, the user can enter text for a header and/or footer, and can select the font and font size, as well as the alignment. The information can be entered into displayed fields 56A through 56H. Some of the displayed fields provide drop-down menus from which the user can make a selection.

Another window 58 (FIG. 4D) allows the user to enter information for Bates type or other sequential numbering of the documents. This numbering can be in addition to any numbering that already is on the documents. For example, if the documents are to be printed for the purpose of a deposition, they can be numbered separately from any numbering that previously was applied to the documents during production. The user can enter the type of template for the Bates numbering, the starting value for the Bates numbering, the location of the numbering on the document, as well as the font and font size. The information can be entered into fields 58A through 58K. Drop-down menus are provided to facilitate selection of some of the features. Additional information regarding numbering (e.g., first and last Bates number of the document; one or more name identifying the entire set of Bates-stamped documents) can be entered as well, as illustrated in FIG. 4C.

The user can navigate from one window to the next by clicking the “Next Step” button at the bottom of FIGS. 4A through 4B. Alternatively, the user can navigate directly to any of the windows by directly clicking the desired option at the top of the window below the heading “Batch Print.”

After entering the information specifying the specifications for the print job, the user clicks the “Finish” button 60. The system displays a Confirmation window 62 (FIG. 5) which allows the user to review her choices. To implement the print job, the user clicks the “Continue” button 64, which causes the system to save the print job list.

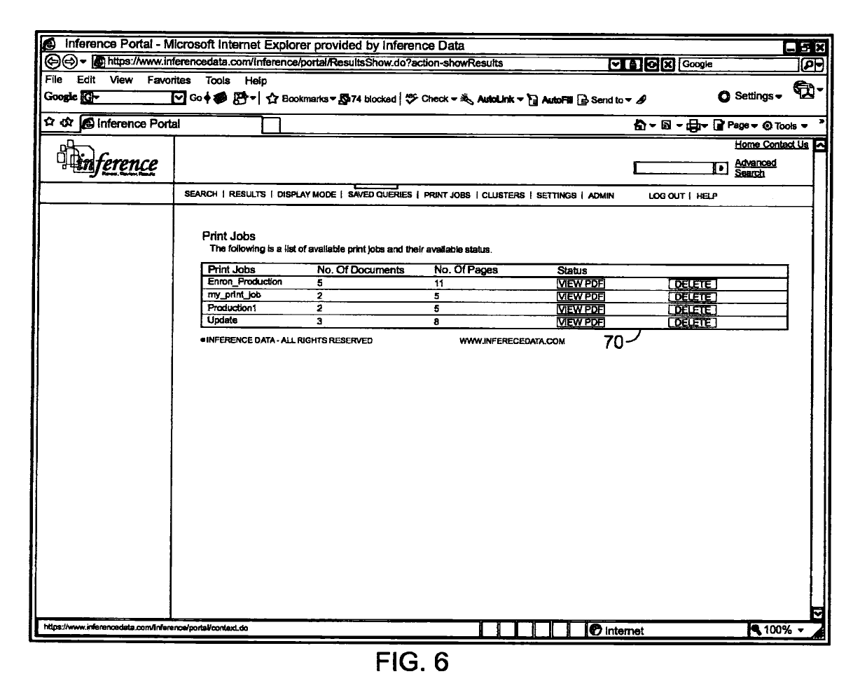

To access a print job, the user selects the “Print Jobs” link 46 in the function bar 10 12 on the results screen 20 (FIG. 2). In response, the system displays a screen 70 (FIG. 6) that allows the user to select a “View PDF” button associated with the particular print job. The system then displays a “File Download” window, which prompts the user to open, save or cancel the batch print job.

There may be situations in which the user wishes to print the contents of the Results page as they are displayed, for example, in FIG. 2, rather than the actual documents resulting from the search. In that case, the user can click on either the EXCEL button 22B or the TEXT button 22C. Printing in either of these formats does not automatically save the output to the print job list; the output would need to be saved manually after it is generated by the system.

If the user selects the EXCEL button 22B, the system generates a spreadsheet of the records listed on the Results screen. If the user selects the TEXT button 22C, the system generates a Notepad file of the records listed on the Results screen with the output results are delimited by commas, which can be useful for importing the data to an alternative spreadsheet or database application. In either case, the system displays a window and prompts the user to save or cancel the print job request. If the user chooses to save the print job request, the system will display a window which prompts the user to open, save or cancel the print job.

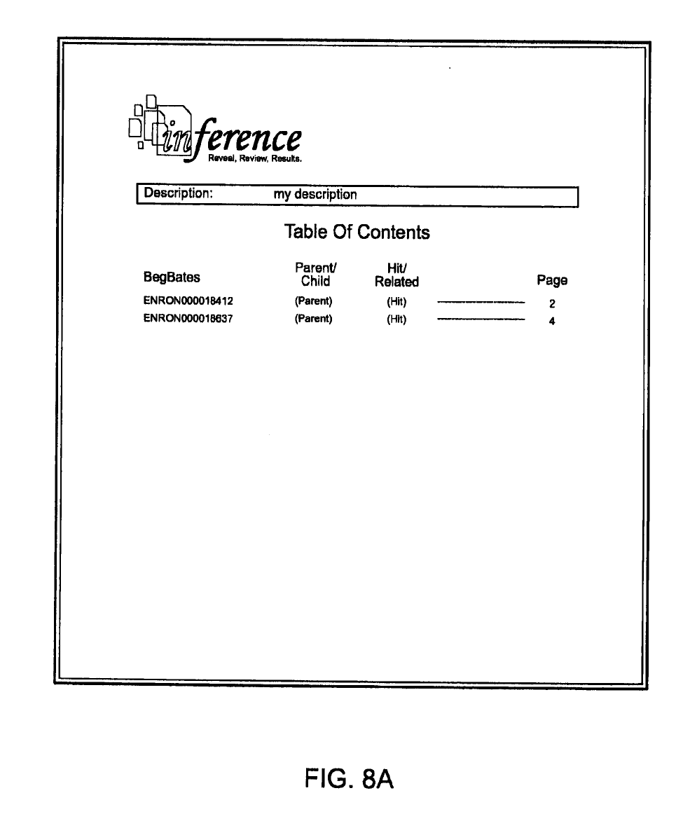

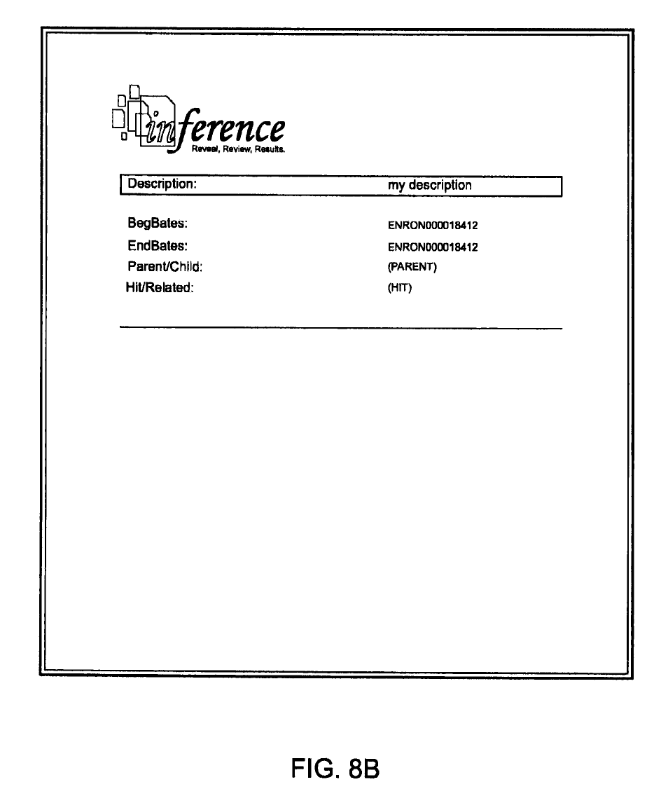

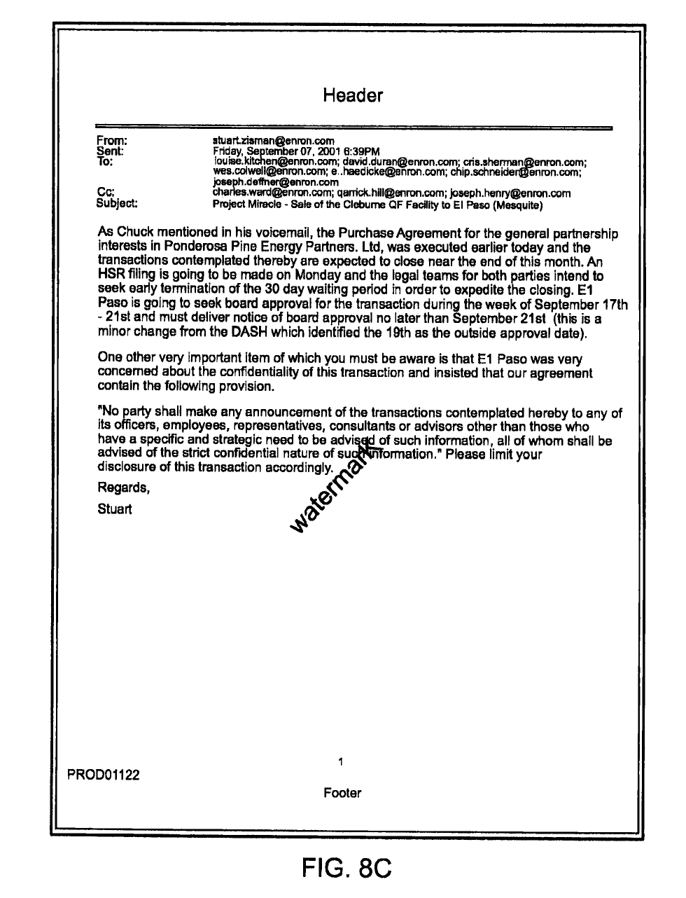

Assuming that the user saves the job, the selected documents will be printed in accordance with the specifications chosen by the user. FIGS. 8A through 8C illustrate sample pages of a pdf print production.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

The web-based system can be implemented to include one or more servers coupled to a database storing the documents. The servers are configured to perform the system functions discussed above. The user can access the system using, for example, a laptop or desktop personal computer that is coupled to the server(s) via the Internet and has an associated printer for printing the documents.

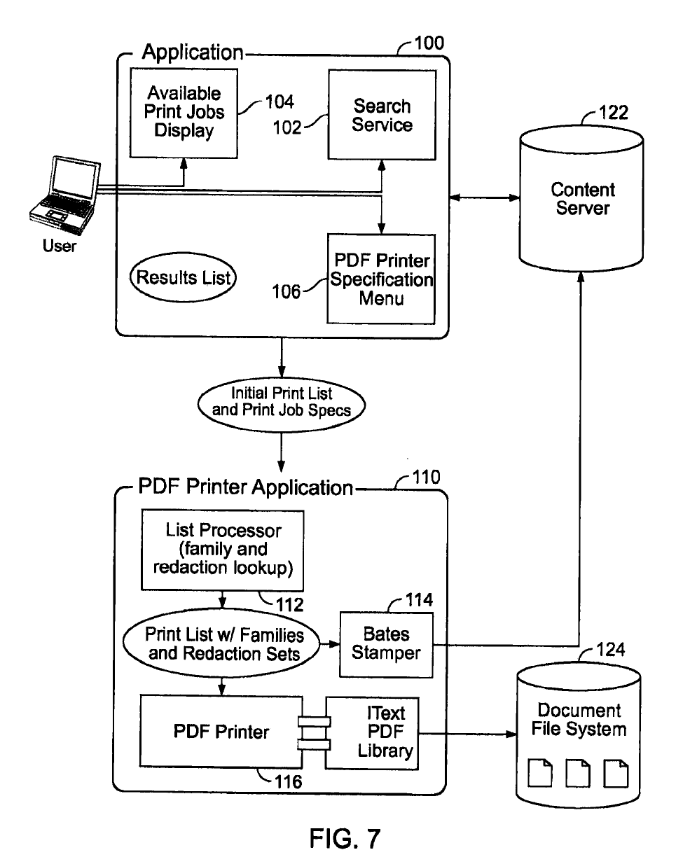

FIG. 7 illustrates an example of the architecture for the system described above. The illustrated system includes a first web-based data analysis and document review application 100 and a second printer application 110. A user can interact with the first application 100, for example, through a personal computer or other user terminal 120.

The first application 100 includes a search service engine 102, a second engine 104 to display available print jobs, and a third engine 106 to provide the printer specification menu. In a particular implementation, the application is based on an Autonomy Intelligent Data Operating Layer™ (IDOL™) engine. An initial print list and print job specifications are sent from the first application 100 to the second application 110.

The second application 110 includes a list processor engine 112 which can query a relational database to obtain information about related and redacted documents. The list processor engine 112 generates a print list that identifies the related families of documents and the redaction sets. The print list is provided to a bates stamp engine 114 and a printer engine 116. The applications 100, 110 can access information from a content server 122 and store information in a document file system 124.

A user at the terminal 120 can request the web-based application 100 to execute a search query and produce a result set of documents. The user then can request a PDF print and, through the interactive menu, can enter the desired print specifications such as selection of a redaction set, inclusion of related documents, placement of headers, footers and watermarks, bates stamping and inclusion of a table of contents.

The system processes the initial print list and the specifications to create a final print list. In some implementations, if the list exceeds a maximum number of pages (e.g., 5000), the system cancels the print job, and the user is presented with a page count and prompted to continue or cancel the print job.

During the print process, as each page is printed, the bates stamps are computed, and headers, footers and watermarks are added. Any new bates stamps are added to the content server 122 by the engine 114. The system assembles the final document, including the table of contents (if any), and makes the final document available on the document file system 124. A “View PDF” button then appears on the Available Print Jobs display (see FIG. 6). The documents are printed in accordance with the user-selected features. A printer (not shown) is provided for that purpose.

Other implementations are within the scope of the claims.

What is claimed is:

1. A method in a web-based data analysis and document review system, the method comprising:
providing a graphical user interface that allows a user to select print options for a group of documents stored by the system, wherein the print options include a plurality of different print formats each of which offers the user a respective set of features which can be selected for printing the particular group of documents as part of a batch print job.

2. The method of claim 1 wherein at least one of the print formats gives the user the ability to choose whether the printed documents are to include a watermark, a header, a footer, or Bates-type sequential numbering.

3. The method of claim 2 including printing the documents in accordance with the user-selected features.

4. The method of claim 3 wherein at least one of the print formats gives the user the ability to specify text for the watermark, to choose a font or font size of the watermark, or to choose an angle of the watermark to appear on the printed documents.

5. The method of claim 3 wherein at least one of the print formats gives the user the ability to specify text for the header or footer, to choose a font or font size of the header or footer, or to choose an alignment for the header or footer.

6. The method of claim 3 wherein at least one of the print formats gives the user the ability to specify a type of template for the sequential numbering, a start value for the numbering, a location for the numbering, or a font or font-size for the numbering.

7. The method of claim 3 wherein at least one of the print formats gives the user the ability to choose whether redacted versions of documents for the group of documents are to be included for printing, wherein the user can select a redaction set from among a list of available redaction sets.

8. The method of claim 7 wherein at least one of the print formats gives the user the ability to select how redacted materials are to appear in printed versions of the documents.

9. The method of claim 3 wherein at least one of the print formats gives the user the ability to choose whether documents related to the documents in the group are to be printed.

10. The method of claim 9 wherein the user has the ability to choose whether the related documents are to be identified in a printed table of contents in the batch print job.

11. The method of claim 3 wherein at least one of the print formats gives the user the ability to choose whether a separator page is to be provided between printed documents in the batch print job.

12. A web-based data analysis and document review system comprising:
a user terminal; and
one or more a servers coupled to the user terminal to provide a graphical user interface that allows a user to select print options for a group of documents stored by the system, wherein the print options include a plurality of different print formats each of which offers the user a respective set of features which can be selected for printing the particular group of documents as part of a batch print job.

13. The system of claim 12 wherein at least one of the print formats gives the user the ability to choose whether the printed documents are to include a watermark, a header, a footer, or Bates-type sequential numbering.

14. The system of claim 13 operable to print the documents in accordance with the user-selected features.

15. The system of claim 14 wherein at least one of the print formats gives the user the ability to specify text for the watermark, to choose a font or font size of the watermark, or to choose an angle of the watermark to appear on the printed documents.

16. The system of claim 14 wherein at least one of the print formats gives the user the ability to specify text for the header or footer, to choose a font or font size of the header or footer, or to choose an alignment for the header or footer.

17. The system of claim 14 wherein at least one of the print formats gives the user the ability to specify a type of template for the sequential numbering, a start value for the numbering, a location for the numbering, or a font or font-size for the numbering.

18. The system of claim 14 wherein at least one of the print formats gives the user the ability to choose whether redacted versions of documents for the group of documents are to be included for printing, wherein the user can select a redaction set from among a list of available redaction sets.

19. The system of claim 18 wherein at least one of the print formats gives the user the ability to select how redacted materials are to appear in printed versions of the documents.

20. The system of claim 14 wherein at least one of the print formats gives the user the ability to choose whether documents related to the documents in the group are to be printed.

21. The system of claim 20 wherein the user has the ability to choose whether the related documents are to be identified in a printed table of contents in the batch print job.

22. The system of claim 14 wherein at least one of the print formats gives the user the ability to choose whether a separator page is to be provided between printed documents in the batch print job.

23. An article comprising a machine-readable medium that stores machine-executable instructions for causing a machine in a web-based data analysis and document review system to:
provide a graphical user interface that allows a user to select print options for a group of documents stored by the system, wherein the print options include a plurality of different print formats each of which offers the user a respective set of features which can be selected for printing the particular group of documents as part of a batch print job.

24. The article of claim 23 wherein at least one of the print formats gives the user the ability to choose whether the printed documents are to include a watermark, a header, a footer, or Bates-type sequential numbering.

25. The article of claim 24 including instructions for causing the documents to be printed in accordance with the user-selected features.
